(19) United States
(12) Patent Application Publication
(10) Pub. No.: US 2004/0173958 A1
(43) Pub. Date: Sep. 9, 2004

(54) Method of delivering a printed product to a binding or mailing line

(75) Inventor: William T. Graushar, Wauwatosa, WI (US)

Correspondence Address: Billie Jean Smith, Michael Best & Friedrich LLP, 100 East Wisconsin Avenue, Milwaukee, WI, 53202-4108, US

(73) Assignee: Quad/Graphics, Inc., Sussex, WI

(21) Appl. No.: 10/378,135

(22) Filed: Mar. 4, 2003

(51) Int. Cl. B42B 2/00

(52) U.S. Cl. 270/52.02

(57) ABSTRACT

The invention relates to a method of sequentially delivering printed products to a binding or mailing line. Each printed product includes order indicia thereon and is delivered to a feeder adjacent the binding or mailing line. The order indicia is read by a reader and analyzed by a controller. The controller transmits a signal to the feeder to deliver the printed products to the binding line or mailing line based on a predetermined order.

### FIELD OF THE INVENTION

The present invention relates to a method of delivering a printed product to a binding or mailing line, and more particularly to a method of sequentially delivering printed products to a binding or mailing line.

### BACKGROUND OF THE INVENTION

Book as used herein refers to books, catalogs, magazines, pamphlets, envelopes and other printed materials. Books are typically assembled through either conventional saddle stitch or perfect binding processes and it should be noted that the present invention may be used in conjunction with saddle stitch, perfect binding, and other binding methods.

Publishers of printed media are continually looking to gain market share by maintaining and increasing the number of subscribers to its printed media. To help the publishers achieve their goals, printers provide publishers the capability of customizing printed media based on general demographic regions, the particular recipient, and the recipient's interests.

Books are generally comprised of one or more signatures. Signature as used herein generically refers to paper pages and/or packaging inserts. A signature may be printed by a printing press, a laser printer, an ink jet printer, a non-contact printer or any other type of printer. Printed products include both books and signature.

A book may be customized by including particular signatures within the book based on the location where the book will be sold. Books may be customized by including particular signatures within the book based on characteristics and interests of the recipient. Books may also be customized with the addition of inserts, inserts, electronic media, and the like.

A book may be further customized by including unique personalized information or indicia related to the recipient. A common way to personalize the book is to print the recipient's name and address information on the cover of the book once the book is assembled. The book may be further personalized by printing personalized indicia onto one or more signatures before or after the signatures are assembled into a book.

Signatures are often personalized while they are on the binding line by using an ink jet printer positioned near the binding line. As the signatures pass the ink jet printer, personalized information or indicia is printed onto one or more of the signatures or covers. Signatures may also be pre-personalized in a separate off-line printing process prior to being fed onto the binding line.

### SUMMARY OF THE INVENTION

The present invention provides a method of assembling a book on a binding line including generating a book assembly order, providing a plurality of printed products each including a sequence code, loading the plurality of printed products into the plurality of feeders, reading the code on the printed product that is next-in-line to be delivered to the binding line for each feeder, and delivering one of the next-in-line printed products to the binding line based on the assembly order.

The present invention provides a method of generating a book on a binding line including printing a plurality of signatures, each signature including a sequence code, storing the plurality of signatures on a plurality of rolls, placing the plurality of rolls adjacent to the binding line, delivering a signature from each roll to the respective pocket on the binding line, scanning the sequence code on each signature, analyzing the sequence code, and delivering a signature to the binding line based on the sequence code.

The present invention provides a method of combining a plurality of mail streams into one mail stream, each piece of mail including a sequence code including providing a mailing line including a plurality of pockets, placing the plurality of mail streams into the plurality of pockets, one mail stream in each pocket, reading the sequence code on the pieces of mail that are next-in-line to be delivered to the mailing line, and delivering the piece of mail to the mailing line based on the sequence code.

### BRIEF DESCRIPTION OF THE DRAWINGS

FIG. 1 is a plan view of a binding line for assembling a book.

FIG. 2 is an exemplary illustration of a roll of signatures including sequence codes.

FIG. 3 is a flow chart illustrating a method of delivering a signature to the binding line.

FIG. 4 is a flow chart illustrating a method of delivering a book to a mailing line.

FIG. 5 is a plan view of a binding line for assembling a book.

FIG. 6 is a plan view of a POD printer feeder.

FIG. 7 is a plan view of the POD printer feeder.

### DETAILED DESCRIPTION OF THE EMBODIMENTS

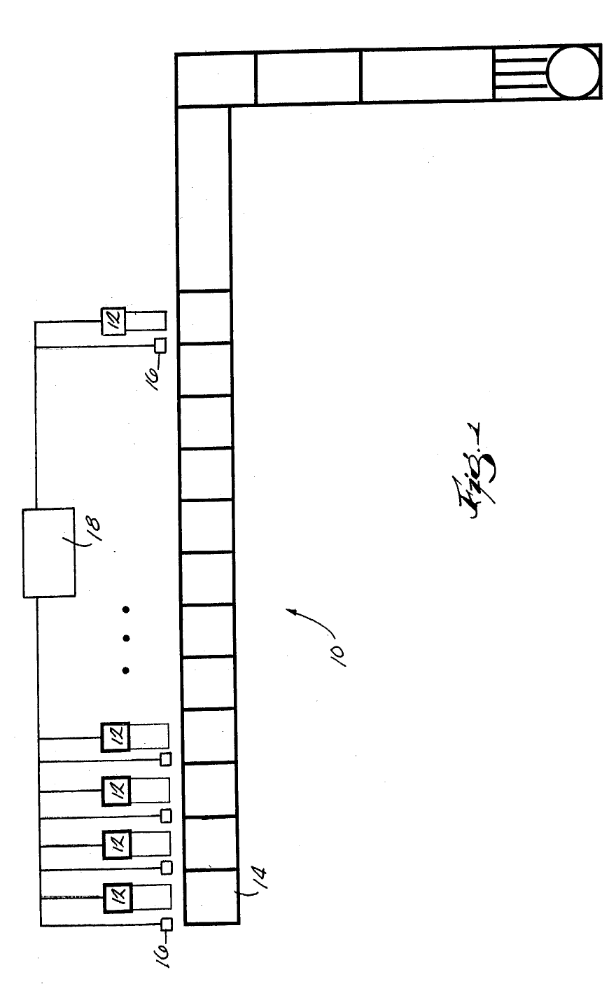

FIG. 1 illustrates a binding line 10 for assembling books. The binding line 10 includes a plurality of feeders 12 and a conveyor line 14. The feeders 12 contain signatures that will comprise a book. Although only five feeders 12 are shown delivering signatures to the conveyor line 14, it should be understood that binding line 10 may include additional or less feeders 12. In addition, any conventional feeder 12 can be used as part of the binding line 10 without departing from the scope of the present invention.

The binding line 10 includes a reader 16, i.e., bar code reader, scanner, etc., adjacent to each feeder 12. The readers 16 connect to a controller 18, as is known in the art, that processes the output from the readers 16. A suitable controller 18 is the FCS 2000 available from Quad/Tech, Inc. in Sussex, Wis. The controller 18 connects to the feeders 12 to control the delivery of the appropriate signature to the conveyor line 14.

The binding line 10 may include additional feeders, a print station, an inspection station, a stitcher, a trimming station, and a stacker downstream of the feeders 12 as are known in the art. The additional feeders positioned downstream of the feeders 12 may feed additional signatures and/or selective items, such as, order forms, postcards, special-interest publications, CD-ROMs, DVDs, subscription cards, promotional offers, coupons, etc. The print station can include an ink jet printer that prints personalized indicia, i.e., recipient name and address, on the cover or on an interior page of a book. The inspection station inspects each book for appropriate thickness or print quality by a caliper or other sensor. This information is transmitted to the controller 18, which compares the measured thickness or print quality with a reference thickness or print quality in order to determine if the book has been appropriately assembled. If an error was made in the assembly of the book, the book is rejected from the binding line 10.

The stitcher binds, i.e., stapled, glued, stitched, and fastened, each book, and the trimming station trims the edges of each book. The stacker bundles together books that are being delivered to a common zip code, or other predetermined order, for easy handling by the U.S. Postal Service. Other stations or operations may be included in the binding line 10 that are known in the art.

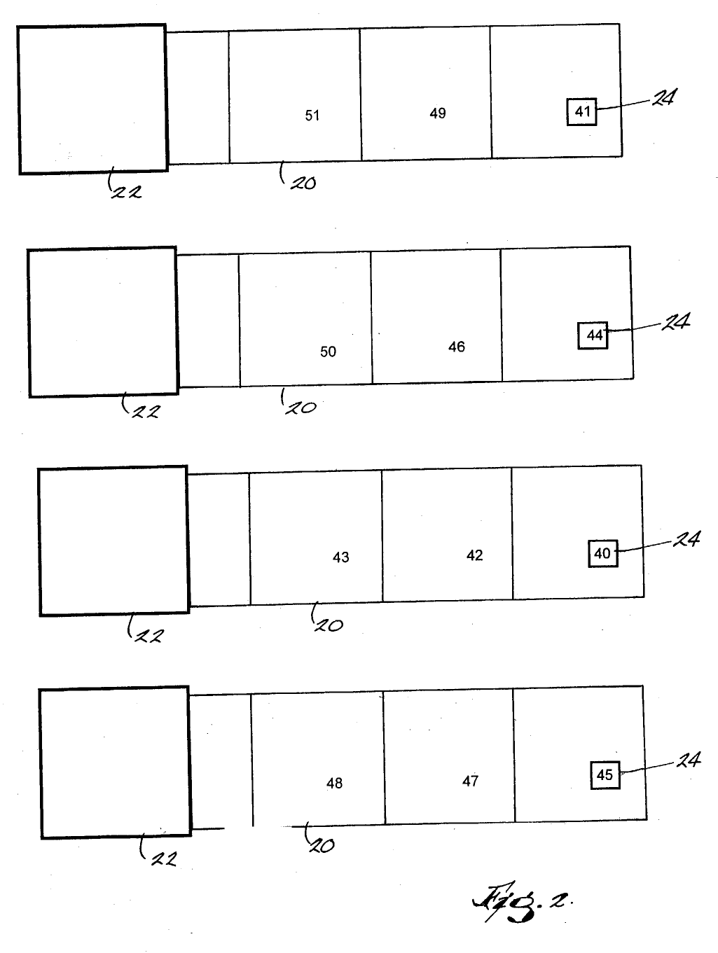

FIG. 2 illustrates stored signatures such as on the four rolls 22. The pre-printed signatures 20 may also be wound onto a roll 22 in a fan fold method. Further, other storage methods may also be utilized in addition to rolls such as containers, piles, and the like, that keep a sequence. Each signature 20 on a roll may have the same content or different content depending on the publication. The content may include advertising, special promotional offers, or subscriber indicia, and the content may vary depending on the subscriber's demographics and interests. Each signature 20 includes thereon a sequence code 24. The sequence code 24 may be a U.S. Postal Service zip code, a bar code, a reference number, a sequence number or any identifying code. The sequence code 24 may be printed with invisible ink.

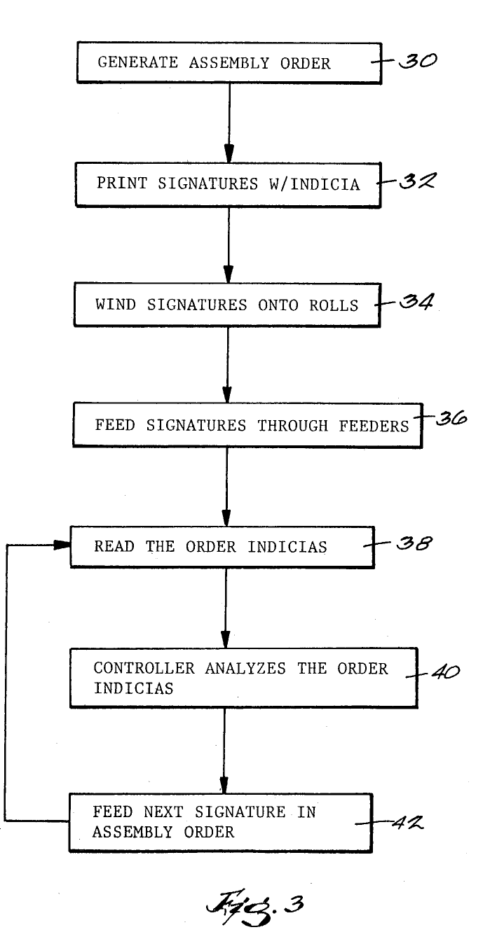

One embodiment of the method of the invention is illustrated in the flow chart in FIG. 3. Prior to printing the signatures 20, an assembly order is generated at step 30. The assembly order may be an order to build the books being delivered to a common zip code, or other predetermined order, for easy handling by the U.S. Postal Service or any other delivery service. Based on the assembly order, signatures are printed that each include the sequence code 24 at step 32. At step 34, the printed signatures 20 are wound onto one of several rolls 22 according to the assembly order.

Each wound roll 22 is positioned adjacent to a feeder 12 and each signature 20 is separated from the role and fed through the corresponding feeder 12 toward the reader 16 at step 36. At step 38, the reader 16 reads the sequence code 24 on each signature that is nearest the conveyor line 14, that is, next-in-line. At step 40, the controller 18 analyzes the outputs from each of the readers 16 to determine which signature of those that are next-in-line for each roll 22 is next in the assembly order. The controller 18 sends a signal to a respective feeder 12 to feed the next signature in the assembly order at step 42. Once a signature is fed to the conveyor line 14, the next signature on the roll takes its place as being next-in-line. The process continues at step 38. The reader 16 reads the sequence code 24 on each signature that is next-in-line for each roll 22. The controller 18 analyzes the reader 16 output and transmits a signal to the feeder 12 to feed the next signature in the assembly order. It should also be noted that a signature could be separated from its respective roll 22 after the sequence code 24 thereon has been read by the reader 16.

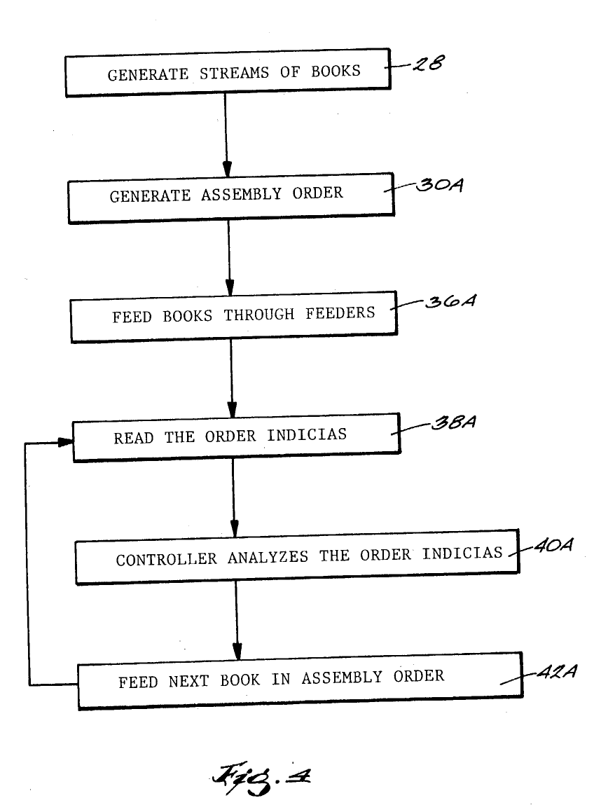

Another embodiment of the invention is illustrated in the flow chart in FIG. 4. Common steps are identified by the same reference number with an appended “A”. Several streams of books including order indicia 24 are generated in an off-line process at step 28. The streams of books may be the same publication or various types of publications, mail, or other printed pieces. Each stream of books may also be of a differing class of mail, e.g., first class, second class, or third class, from another stream of books. Each stream of books may also include mixed classes of printed pieces. The combination of streams of books reduces costs to mailers and reduces the handling costs to the U.S. Postal Service.

Next, an assembly order is generated at step 30A by analyzing the various files that generated each stream of books. Each stream of books is fed to a feeder 12. Each book is fed through the corresponding feeder 12 toward the reader 16 at step 36A. The reader 16 reads, at step 38A, the sequence code 24 on each book that is nearest the conveyor line 14. At step 40A, the controller 18 analyzes the outputs from each of the readers 16 to determine which book is next in the assembly order. The controller 18 sends a signal to the feeder 12 to feed the next book in the assembly order at step 42A to the mailing line. The process continues at step 38A. The reader 16 reads the order indicia 24 on each book that is nearest the conveyor 14. The controller 18 analyzes the reader 16 output and transmits a signal to the feeder 12 to feed the next book in the assembly order.

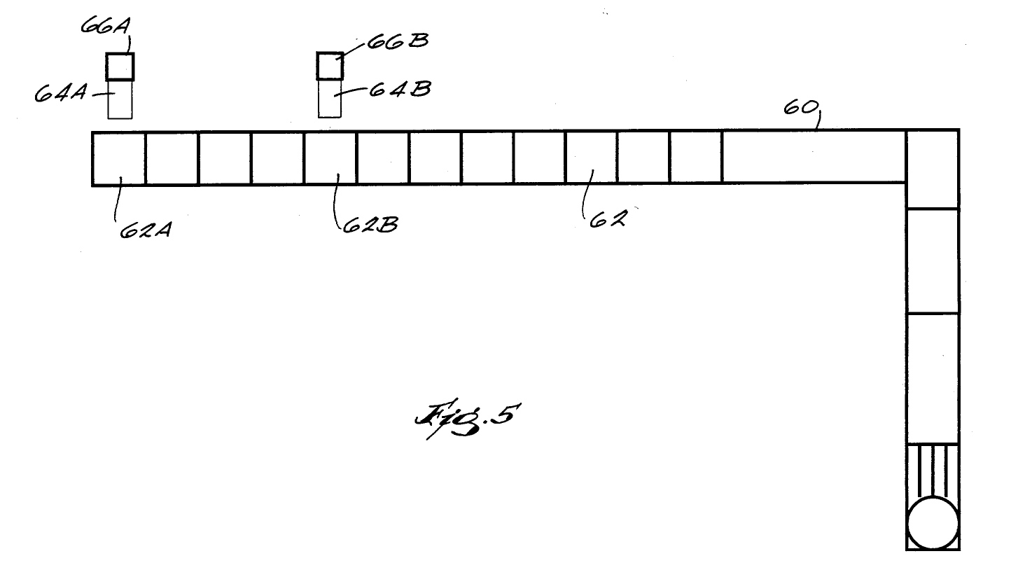

Turning now to FIGS. 5-7, another embodiment of the invention is shown. In this embodiment, print-on-demand (POD) technology is utilized as a way to have multiple printed product streams gathered together using one pocket and as a result actually creating one stream. POD technology enables the use of one pocket to combine individual streams of printed products. POD technology can be used in conjunction with traditional feeders and pockets if different sized signatures, varying folding techniques, increased speed, back-up efficiencies, additional color requirements, for example, are desired. In other cases, one POD component may be sufficient.

As shown in FIG. 5, a binding line 60 includes multiple pockets 62. Pockets 62A and 62B have associated therewith a POD feeder 64A and 64B, respectively, each have thereon a POD printer 66A and 66B, respectively.

Multiple POD technology components can be used on the binding line 60 as shown in FIG. 5. As an example, the first POD feeder 64A prints and feeds the driver piece using a bar code as described above and the second POD feeder 64B prints and feeds in sequence to match the driver piece. Scanners, cameras or similar technology could be used to verify that the match of these signatures have in fact been established.

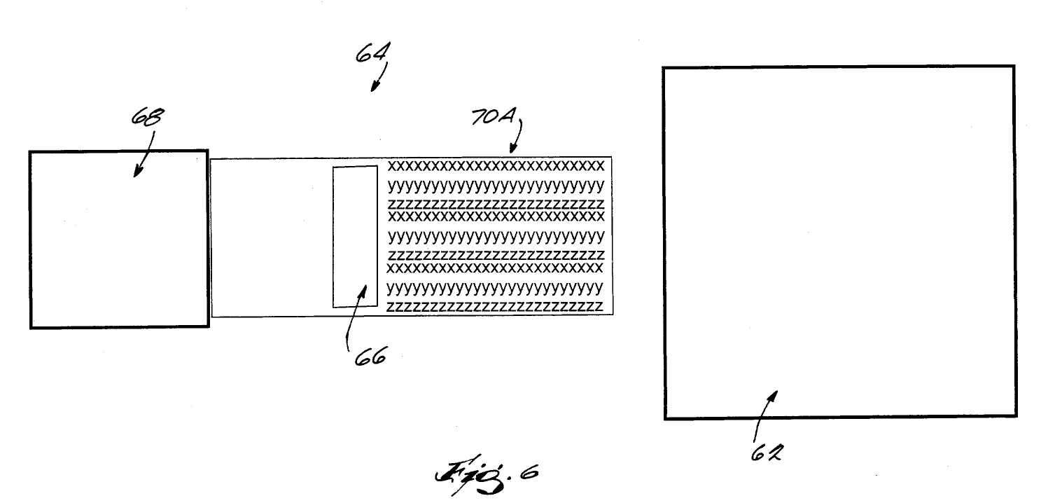

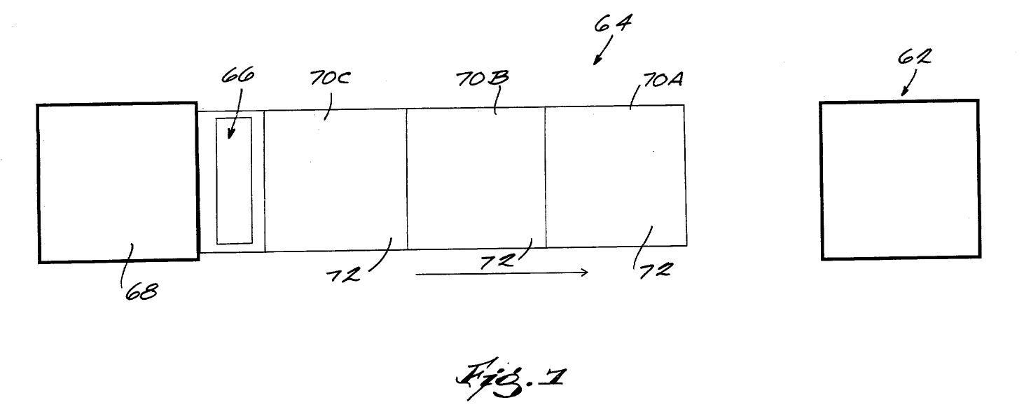

Referring now to FIGS. 6 and 7, POD technology enables all the information required on the printed products, such as a signature, to be printed at the same time. Borders, varying colors, common text and/or variable text, for example, can all be printed on demand in real time, therefore, individual streams of printed products can be printed as one mail stream and with the use of one pocket. Examples of POD technology include the VersaMark Printing System available from Scitex and the DocuTech Production Printer available from Xerox. A blank roll of paper 68 is fed to the POD printer 66 which prints each individual printed product, such as signatures 70A, 70B and 70C. The printed products 70 are then fed to the pocket 62.

It should be noted that with all embodiments, books do not need to be assembled in the exact assembly order to ensure that the books are being manufactured correctly. Due to the sequence code and/or POD technology being utilized, a book can be assembled correctly as controlled by the controller, based on the code alone, regardless of sequence order. If mailing requirements change, the precise sequence the books are manufactured in becomes less important.

The present invention is not limited to the forms shown and described above. Alternate forms will be apparent to those skilled in the art and are within the intended scope of the present invention. The forms described herein are further intended to explain the best modes known for practicing the invention and to enable those skilled in the art to utilize the invention in such, or other, forms and with various modifications required by the particular applications or uses of the present invention. It is intended that the appended claims be construed to include alternative forms to the extent permitted by the prior art.

What is claimed is:

1. A method of assembling a book on a binding line comprising:
generating a book assembly order;
providing a plurality of printed products each including a sequence code;
loading the plurality of printed products into a plurality of feeders;
reading the code on the printed product that is next-in-line to be delivered to the binding line for each feeder; and
delivering one of the next-in-line printed products to the binding line based on the assembly order.

2. The method as set forth in claim 1 wherein the code is a machine readable code.

3. The method as set forth in claim 1, wherein the printed products are pre-printed laser signatures.

4. The method as set forth in claim 1, wherein the printed products are signatures printed adjacent to the binding line by a print-on-demand printer.

5. The method as set forth in claim 1, wherein the act of providing a plurality of printed products includes providing a plurality of rolls, wherein the printed products are wound onto the rolls.

6. The method as set forth in claim 5, wherein the printed products on a roll include similar information.

7. The method as set forth in claim 5, wherein the printed products on a roll include different information.

8. The method as set forth in claim 1, wherein the code is a bar code.

9. The method as set forth in claim 1, wherein the code is invisible to human sight.

10. A method of generating a book on a binding line method comprising:
printing a plurality of signatures, each signature including thereon a sequence code;
storing the plurality of signatures on a plurality of rolls;
placing the plurality of rolls adjacent to the binding line;
delivering a signature from each roll to a respective pocket on the binding line;
scanning the sequence code on each signature;
analyzing the sequence code; and
delivering a signature to the binding line from one of the pockets based upon the sequence code.

11. The method as set forth in claim 10, wherein the signatures are laser printed.

12. The method as set forth in claim 10, wherein the signatures are pre-personalized.

13. The method as set forth in claim 10, wherein the signatures on a particular roll include similar information.

14. The method as set forth in claim 10, wherein the signatures on a particular roll include different information.

15. The method as set forth in claim 10, wherein the code is machine readable.

16. The method as set forth in claim 10, wherein the code is a bar code.

17. A method of combining a plurality of mail streams into one mail stream, each piece of mail including a sequence code, the method comprising:
providing a mailing line including a plurality of pockets;
placing the plurality of mail streams into the plurality of pockets, one mail stream in each pocket;
reading the sequence code on the pieces of mail that are next-in-line to be delivered to the mailing line; and
delivering one of the next-in-line pieces of mail to the mailing line based on the sequence code.

18. The method as set forth in claim 17, wherein the sequence code is a zip code.

19. The method as set forth in claim 17, wherein the sequence code is machine readable.

20. The method as set forth in claim 17, wherein the sequence code is bar code.

21. The method as set forth in claim 17, wherein at least one of the mail streams is of a different postal class than the other mail streams.

22. The method as set forth in claim 17, wherein the pieces of mail in at least one of the mail streams includes pieces of mail in different postal classes.

23. A method of assembling a book on a binding line comprising:
generating a book assembly order;
providing a plurality of printed products each including a sequence code, a portion of the printed products being printed adjacent the binding line using a print-on-demand printer;
loading the plurality of printed products into a plurality of feeders;
reading the code on the printed product that is next-in-line to be delivered to the binding line for each feeder; and
delivering one of the next-in-line printed products to the binding line based on the assembly order.
